(19) United States
(12) Patent Application Publication
(10) Pub. No.: US 2018/0370509 A1
(43) Pub. Date: Dec. 27, 2018

(54) Brake Apparatus, Brake System, and Method for Controlling Brake Apparatus

(71) Applicant: Hitachi Automotive Systems, Ltd., Hitachinaka-shi, Ibaraki (JP)

(72) Inventors: Hideaki YAGASHIRA, Zama-shi, Kanagawa (JP); Toshiya OOSAWA, Yokohama-shi, Kanagawa (JP); Asahi WATANABE, Kawasaki-shi, Kanagawa (JP)

(21) Appl. No.: 16/060,333

(22) PCT Filed: Nov. 11, 2016
(86) PCT No.: PCT/JP2016/083453

§ 371 Date: Jun. 7, 2018

(30) Foreign Application Priority Data
Dec. 9, 2015 (JP) 2015-239893

(51) Int. Cl. B60T 13/16; B60T 17/22; B60T 13/68

(52) U.S. Cl. CPC B60T 13/168; B60T 13/165; B60T 13/18; B60T 13/686; B60T 17/221; B60T 17/226

(57) ABSTRACT

Provided is a brake apparatus capable of securing a braking force on a vehicle even at the time of a fluid leak. The brake apparatus performs control so as to continue generation of a brake hydraulic pressure to be supplied to a wheel cylinder with use of a second hydraulic source if a fluid leak of brake fluid is determined based on a preset relationship between a hydraulic pressure of a first hydraulic source and a stroke of a brake pedal.

### TECHNICAL FIELD

The present invention relates to a brake apparatus.

### BACKGROUND ART

Various types of conventional brake apparatuses are provided, and, one known example of them is a brake apparatus discussed in PTL 1. An outline of this brake apparatus is as follows. This brake apparatus employs a system that is configured to be able to close a fluid passage between a master cylinder and a wheel cylinder, and generates a pedal feeling with use of a stroke simulator and generates a braking force with use of a hydraulic source other than a pedal operation performed by a driver when closing the fluid passage.

### CITATION LIST

### Patent Literature

[PTL 1] International Publication No. WO2011/096039

### SUMMARY OF INVENTION

### Technical Problem

However, according to PTL 1, if there is a possibility of a fluid leak, a hydraulic pressure of the hydraulic source is supplied to brake cylinders for rear left and right wheels, and a hydraulic pressure of the master cylinder is supplied to brake cylinders for front left and right wheels. Therefore, if a fluid leak from the master cylinder has occurred, the front left and right wheels are subjected to pressing force brake, which raises a possibility of insufficiency of a braking force on a vehicle with respect to an operation amount input to a brake pedal.

An object of the present invention is to provide a brake apparatus capable of securing the braking force on the vehicle even at the time of the fluid leak.

### Solution to Problem

According to one embodiment of the present invention, a brake apparatus performs control so as to continue generation of a brake hydraulic pressure to be supplied to a wheel cylinder with use of a second hydraulic source, if a fluid leak of brake fluid is determined based on a preset relationship between a hydraulic pressure of a first hydraulic source and a stroke of a brake pedal.

Therefore, the insufficiency of the braking force on the vehicle can be avoided even when a failure such as the fluid leak has occurred.

### BRIEF DESCRIPTION OF DRAWINGS

FIG. 1 illustrates a braking system of a vehicle with a brake apparatus according to a first embodiment mounted thereon.

FIG. 2 illustrates the brake apparatus according to the first embodiment.

FIG. 3 is a flowchart illustrating a flow of switching boosting control when a failure is determined based on an estimated stroke that is performed by a control unit according to the first embodiment.

FIG. 4 is a flowchart illustrating a detailed flow of step S4 according to the first embodiment.

FIG. 5 illustrates a relationship between a master pressure and a stroke in the brake apparatus according to the first embodiment.

FIG. 6 illustrates a relationship between a difference of a brake operation amount and a boosting ratio in the brake apparatus according to the first embodiment.

FIG. 7 illustrates a relationship between a stroke S and a wheel cylinder W/C pressure in the brake apparatus according to each of the first to third embodiments.

FIG. 8 illustrates a flow of brake fluid at the time of a fluid leak in a primary system of a master cylinder M/C in the brake apparatus according to each of the first to third embodiments.

FIG. 9 illustrates a flow of the brake fluid when a seal of a stroke simulator SS is stuck in the brake apparatus according to each of the first to third embodiments.

FIG. 10 illustrates a flow of the brake fluid when the brake apparatus operates normally, in the brake apparatus according to each of the first to third embodiments.

FIG. 11 is a flowchart illustrating a flow of switching the boosting control when the failure is determined based on an estimated master pressure that is performed by a control unit according to the second embodiment.

FIG. 12 is a flowchart illustrating a detailed flow of step S4 according to the second embodiment.

FIG. 13 is a flowchart illustrating a flow of switching the boosting control when a boosting control switching determination method is switched based on a switching master pressure threshold value for the booting control switching determination method that is performed by a control unit according to the third embodiment.

FIG. 14 illustrates a relationship between a brake operation speed and a control switching determination threshold value in a brake apparatus according to a fourth embodiment.

FIG. 15 illustrates a brake apparatus according to a fifth embodiment.

### DESCRIPTION OF EMBODIMENTS

### First Embodiment

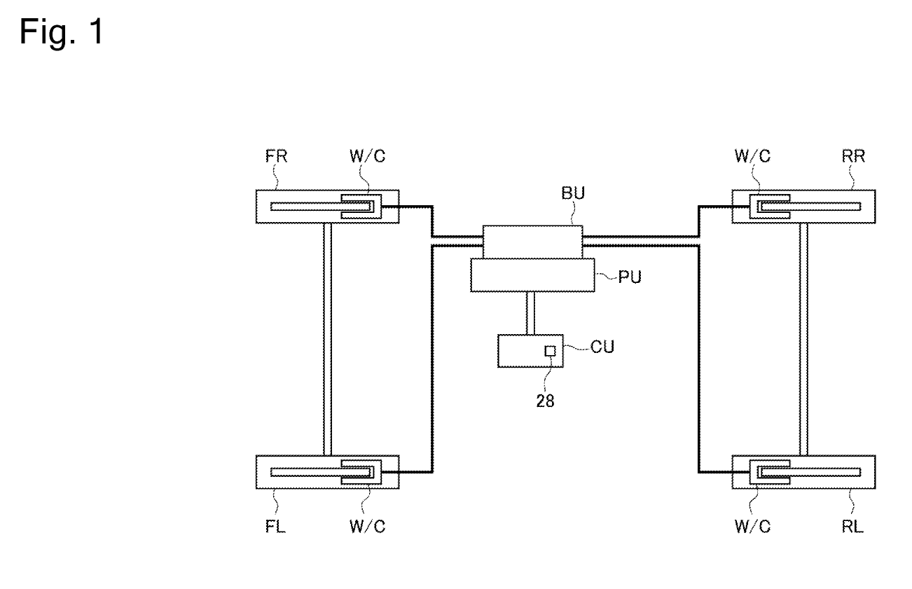

FIG. 1 illustrates a braking system of a vehicle with a brake apparatus according to a first embodiment mounted thereon. A valve unit BU operates based on a driving instruction from a control unit CU, and increases/reduces or maintains hydraulic pressures in a wheel cylinder W/C (FL) for a front left wheel FL, a wheel cylinder W/C (RR) for a rear right wheel, a wheel cylinder W/C (RL) for a rear left wheel RL, and a wheel cylinder W/C (FR) for a front right wheel. Information input to the control unit CU includes each of values detected by a stroke sensor 1, a master pressure sensor 2, a primary system pressure sensor 3, a secondary system pressure sensor 4, and a pump pressure sensor 5 that are provided to the valve unit BU, which will be described below, and various kinds of information regarding a running state from a vehicle side (a wheel speed and the like). The control unit CU includes a brake operation state detection portion 28, which detects a brake operation state from the values detected by the stroke sensor 1 and the master pressure sensor 2. The control unit CU engages in information processing based on the brake operation state, the value detected by each of the sensors, and the various kinds of information, according to a program installed therein. The control unit CU generates the driving instruction directed to the valve unit BU according to a result of the information processing, and controls the brake fluid to be supplied to each of the wheel cylinders W/C.

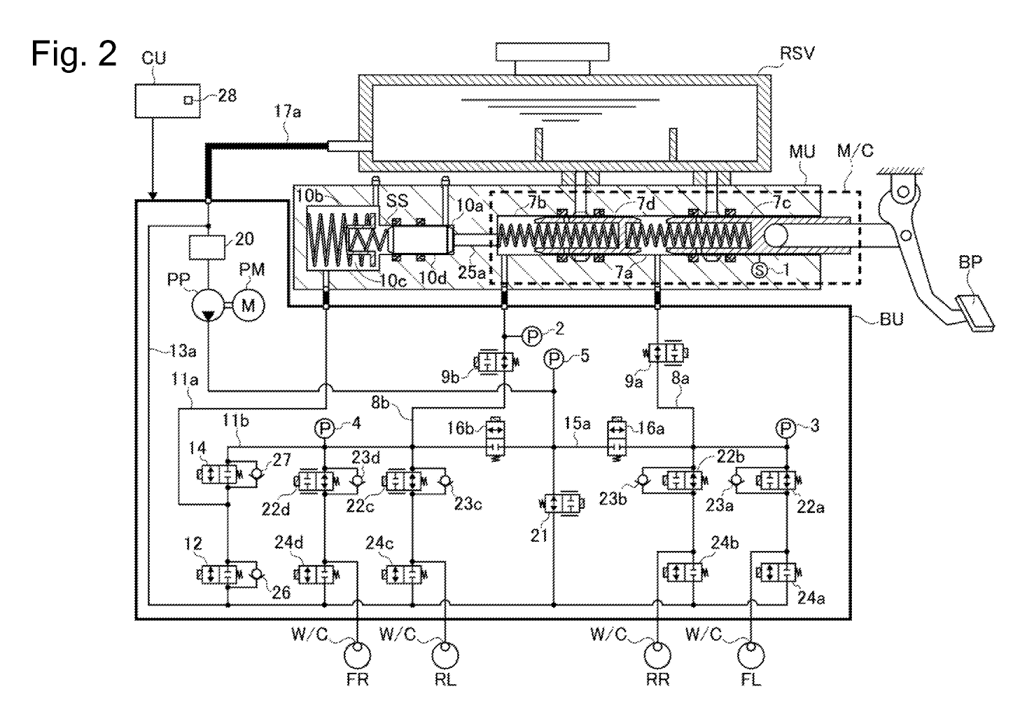

FIG. 2 illustrates the brake apparatus according to the first embodiment. The brake apparatus according to the first embodiment includes a brake pedal BP, a master cylinder unit MU, the valve unit BU, a reservoir tank RSV, and the control unit CU. The master cylinder unit MU and the valve unit BU are configured as different bodies from each other, and form a plurality of oil passages 8a, 8b, and 11a by being assembled to each other with use of a bolt. A connection between these units is not limited to a configuration directly connecting housings thereof, and may be established via a metallic pipe or the like therebetween.

The master cylinder unit MU includes the stroke sensor 1, which detects a brake operation amount input by a driver (a stroke of the brake pedal BP). The master cylinder unit MU includes a master cylinder M/C and a stroke simulator SS. The master cylinder M/C includes a primary fluid chamber 7a and a secondary fluid chamber 7b, and the brake fluid is supplied from the reservoir tank RSV to each of them. When the brake pedal BP is pressed, the brake fluid is output from the primary fluid chamber 7a to a primary system via a primary piston 7c. At the same time, the brake fluid is output from the secondary fluid chamber 7b to a secondary system via a secondary piston 7d. The primary fluid chamber 7a is connected to each of the wheel cylinders W/C for the front left wheel FL and the rear right wheel RR via the oil passage 8a. The secondary fluid chamber 7b is connected to each of the wheel cylinders W/C for the rear left wheel RL and the front right wheel FR via the oil passage 8b.

The primary system pressure sensor 3, which detects a primary system pressure, is provided in the oil passage 8a. The secondary system pressure sensor 4, which detects a secondary system pressure, is provided in the oil passage 8b. A primary cut valve 9a is provided in the oil passage 8a. The primary cut valve 9a blocks communication between the primary fluid chamber 7a and the wheel cylinders W/C. Further, a secondary cut valve 9b is provided in the oil passage 8b. The secondary cut valve 9b blocks communication between the secondary fluid chamber 7b and the wheel cylinders. Both the primary cut valve 9a and the secondary cut valve 9b are normally-opened electromagnetic valves.

A positive pressure chamber 10a and a backpressure chamber 10b of the stroke simulator SS are liquid-tightly defined therebetween, and are configured not to allow the brake fluid to travel therebetween. The positive pressure chamber 10a is connected to an oil passage 25a. The oil passage 25a is connected to the secondary fluid chamber 7b. The master pressure sensor 2, which detects a master pressure, is provided in the oil passage 8b on an upstream side of the secondary cut valve 9b. The stroke simulator SS includes a spring 10c in the backpressure chamber 10b, and generates an operation reaction force on the brake pedal BP according to a stroke of a piston 10d. The backpressure chamber 10P is connected to an oil passage 13a via the oil passage 11a, and is also connected to the oil passage 8b via the oil passage 11a and an oil passage 11b. A stroke simulator OUT valve (a stroke simulator adjustment valve) 12 is provided in the oil passage 11a. A stroke simulator IN valve 14 is provided in the oil passage 11b.

Both the stroke simulator OUT valve 12 and the stroke simulator IN valve 14 are normally-closed electromagnetic valves. Further, a check valve 26 is provided in parallel with the stroke simulator OUT valve 12. The check valve 26 permits an outflow of the brake fluid to the oil passage 11a if a pressure in the oil passage 11a is lower than a pressure in the oil passage 13a. Further, a check valve 27 is provided in parallel with the stroke simulator IN valve 14. The check valve 27 permits an outflow of the brake fluid to an oil passage 15a if a pressure in the oil passage 15a is lower than a pressure in the oil passage 11a. A primary communication valve 16a is provided between the oil passage 8a and the oil passage 15a. The primary communication valve 16a can switch communication/discommunication between the primary system and a pump discharge system. Further, a secondary communication valve 16b is provided between the oil passage 8b and the oil passage 15a. The secondary communication valve 16b can switch communication/discommunication between the secondary system and the pump discharge system. Both the primary communication valve 16a and the secondary communication valve 16b are normally-closed electromagnetic valves. The pump pressure sensor 5, which detects a pump discharge pressure, is provided in the oil passage 15a.

The valve unit BU includes a pump motor PM, which is a brushed motor. The pump motor PM drives a plunger pump PP, and discharges the brake fluid introduced from the reservoir tank RSV via an oil passage 17a to the oil passage 15a. A fluid pool 20 is provided on an intake side of the plunger pump PP in the housing of the valve unit BU. Even at the time of such a failure that the brake fluid leaks out from the oil passage 17a, the brake apparatus can continue control of increasing/reducing wheel cylinder hydraulic pressures by causing the fluid pool 20 to function as a source supplying the brake fluid (to the plunger pump PP), a destination to which the brake fluid is discharged (from the wheel cylinders W/C), or the like.

A pressure adjustment valve 21 is provided between the oil passage 15a and the oil passage 13a, and an extra amount of the brake fluid discharged from the plunger pump PP can be returned to the reservoir tank RSV via the oil passage 13a. The pressure adjustment valve 21 is a normally-opened electromagnetic valve, but may be a normally-closed electromagnetic valve.

A front left wheel pressure increase valve 22a is provided between the oil passage 8a and the wheel cylinder W/C (FL). The front left wheel pressure increase valve 22a adjusts the brake fluid flowing from the oil passage 8a to the wheel cylinder W/C (FL). Further, a check valve 23a is provided in parallel with the front left wheel pressure increase valve 22a. The check valve 23a permits an outflow of the brake fluid to the oil passage 8a if a pressure in the oil passage 8a is lower than the pressure in the wheel cylinder W/C (FL). A front left wheel pressure reduction valve 24a is provided between the wheel cylinder W/C (FL) and the oil passage 13a. The front left wheel pressure reduction valve 24a reduces the pressure in the wheel cylinder W/C (FL).

A rear right wheel pressure increase valve 22b is provided between the oil passage 8a and the wheel cylinder W/C (RR). The rear right wheel pressure increase valve 22b adjusts the brake fluid flowing from the oil passage 8a to the wheel cylinder W/C (RR). Further, a check valve 23b is provided in parallel with the rear right wheel pressure increase valve 22b. The check valve 23b permits an outflow of the brake fluid to the oil passage 8a if the pressure in the oil passage 8a is lower than the pressure in the wheel cylinder W/C (RR). A rear right wheel pressure reduction valve 24b is provided between the wheel cylinder W/C (RR) and the oil passage 13a. The rear right wheel pressure reduction valve 24b reduces the pressure in the wheel cylinder W/C (RR).

A rear left wheel pressure increase valve 22c is provided between the oil passage 8b and the wheel cylinder W/C (RL). The rear let wheel pressure increase valve 22c adjusts the brake fluid flowing from the oil passage 8b to the wheel cylinder W/C (RL). Further, a check valve 23c is provided in parallel with the rear left wheel pressure increase valve 22c. The check valve 23c permits an outflow of the brake fluid to the oil passage 8b if a pressure in the oil passage 8b is lower than the pressure in the wheel cylinder W/C (RL). A rear left wheel pressure reduction valve 24c is provided between the wheel cylinder W/C (RL) and the oil passage 13a. The rear left wheel pressure reduction valve 24c reduces the pressure in the wheel cylinder W/C (RL).

A front right wheel pressure increase valve 22d is provided between the oil passage 8b and the wheel cylinder W/C (FR). The front right wheel pressure increase valve 22d adjusts the brake fluid flowing from the oil passage 8b to the wheel cylinder W/C (FR). Further, a check valve 23d is provided in parallel with the front right wheel pressure increase valve 22d. The check valve 23d permits an outflow of the brake fluid to the oil passage 8b if the pressure in the oil passage 8b is lower than the pressure in the wheel cylinder W/C (FR). A front right wheel pressure reduction valve 24d is provided between the wheel cylinder W/C (FR) and the oil passage 13a. The front right wheel pressure reduction valve 24d reduces the pressure in the wheel cylinder W/C (FR).

All the individual pressure increase valves 22a, 22b, 22c, and 22d are normally-opened electromagnetic valves, and all the individual pressure reduction valves 24a, 24b, 24c, and 24d are normally-closed electromagnetic valves.

At the time of normal braking, which generates a braking force on each of the wheels according to the brake operation amount input by the driver, the control unit CU controls the primary cut valve 9a and the secondary cut valve 9b in their valve-closing directions, controls the simulator IN valve 14 in its valve-closing direction, controls the stroke simulator OUT valve 12 in its valve-opening direction, controls the primary communication valve 16a and the secondary communication valve 16b in their valve-opening directions, and controls the pressure adjustment valve 21 in its valve-closing direction, and also activates the pump motor PM. Controlling each of the components in this manner allows desired brake fluid to be transmitted from the reservoir tank RSV to each of the wheel cylinders W/C via the oil passage 17a, the plunger pump PP, the oil passage 15a, the oil passage 8a, and the oil passage 8b. At this time, a desired braking force can be acquired by feeding back the values detected by the primary system pressure 3, the secondary system pressure sensor 4, and the pump pressure sensor 5 to control a motor rotation of the pump motor PM and the pressure adjustment valve 21 so as to achieve target pressures. Further, the brake fluid transmitted from the primary fluid chamber 7a of the master cylinder M/C is guided to the positive pressure chamber 10a of the stroke simulator SS to cause the piston 10d to move, by which a reaction force is applied to the spring 10c and a reaction force is generated according to the brake pedal operation. Therefore, when the braking operation is performed, the brake apparatus can generate the appropriate braking force, the reaction force of the brake pedal BP, and the stroke.

In the first embodiment, the brake apparatus continues boosting control of the wheel cylinders W/C with use of the pump motor PM according to the brake operation amount input by the driver at the time of occurrence of such a failure that the stroke of the brake pedal BP becomes excessive with respect to the master pressure compared to when the brake apparatus operates normally due to, for example, a leak of the brake fluid from a pipe of the master cylinder M/C. The target hydraulic pressures of the wheel cylinders W/C are calculated from each of the values detected by the stroke sensor 1 and the master pressure sensor 2 similarly to when the brake apparatus operates normally. Therefore, the target hydraulic pressures are unaffected as long as the stroke S of the brake pedal BP or a master pressure Pmc is output. Therefore, the brake apparatus can perform the boosting control of the wheel cylinders W/C in a similar manner to when the brake apparatus operates normally without affecting the wheel cylinder W/C pressures.

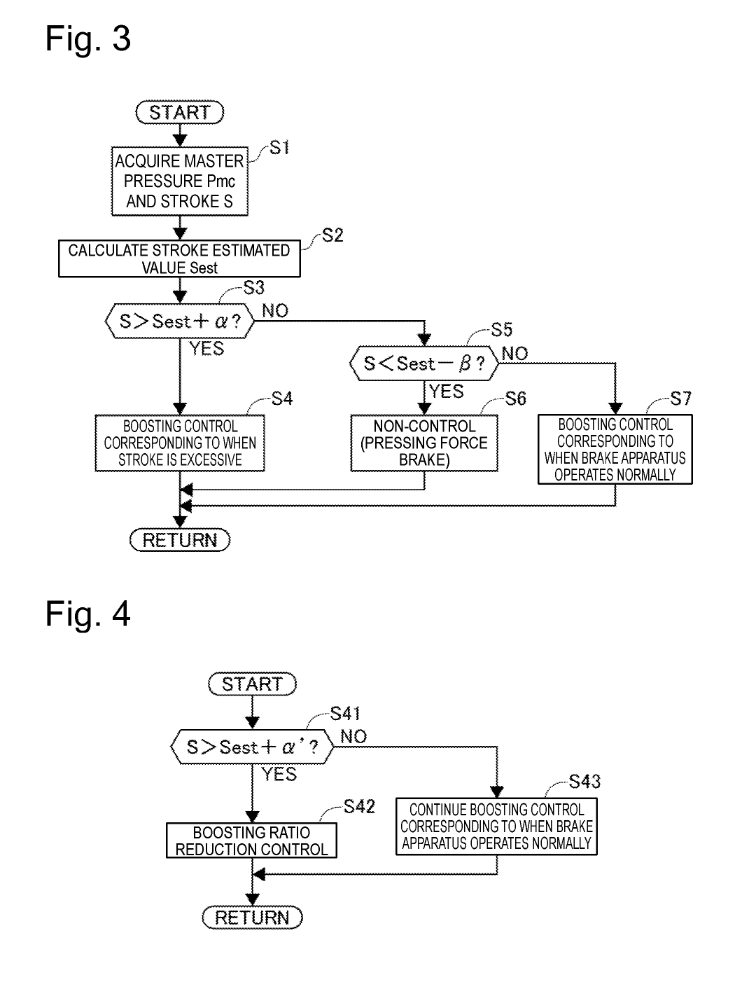

FIG. 3 is a flowchart illustrating a flow of switching the boosting control when a failure is determined based on an estimated stroke Sest that is performed by the control unit CU according to the first embodiment.

In step S1, the control unit CU acquires the stroke S of the brake pedal BP and the master pressure Pmc.

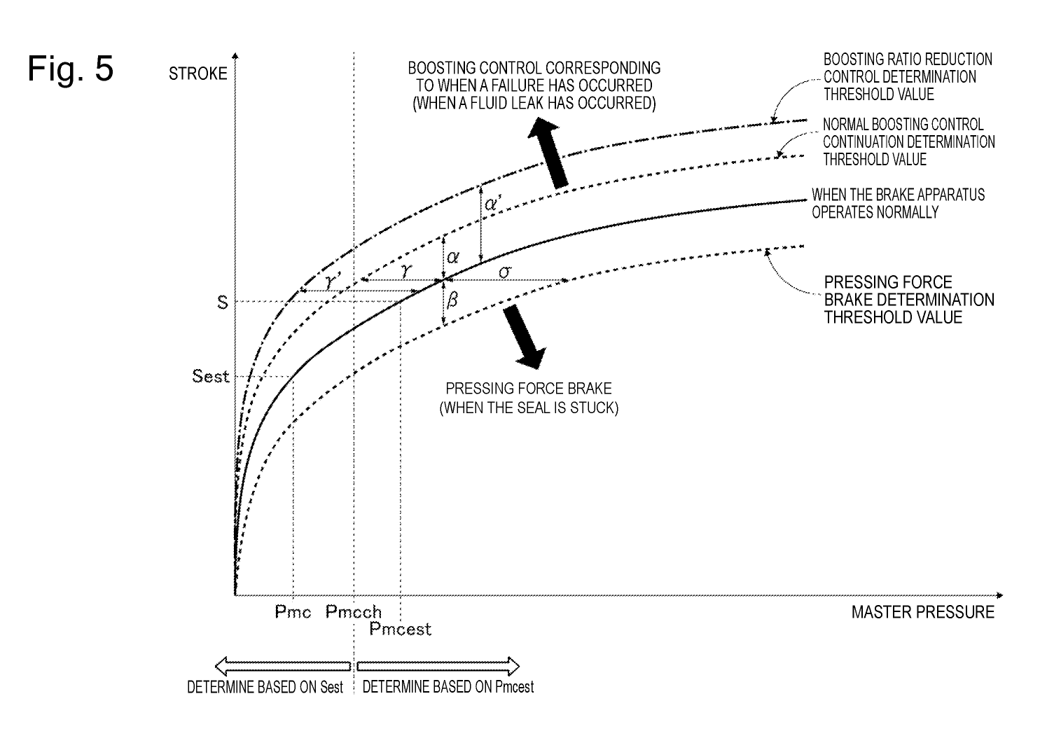

In step S2, the control unit CU calculates the estimated stroke Sest of the brake pedal BP. FIG. 5 illustrates a characteristic indicating a relationship between the master pressure and the stroke of the pedal stroke. The estimated stroke Sest is calculated based on the relationship between the master pressure Pmc and the stroke S of the brake pedal BP corresponding to when the brake apparatus operates normally as indicated by the characteristic corresponding to when the brake apparatus operates normally in FIG. 5.

In step S3, the control unit CU determines whether the stroke S of the brake pedal BP is longer than a first threshold value, which is a value acquired by adding a normal boosting control continuation determination value α to the estimated stroke Sest of the brake pedal BP. If the determination in step S3 is YES, the processing proceeds to S4. If the determination in step S3 is NO, the processing proceeds to S5.

In step S4, the control unit CU performs boosting control corresponding to when the stroke is excessive.

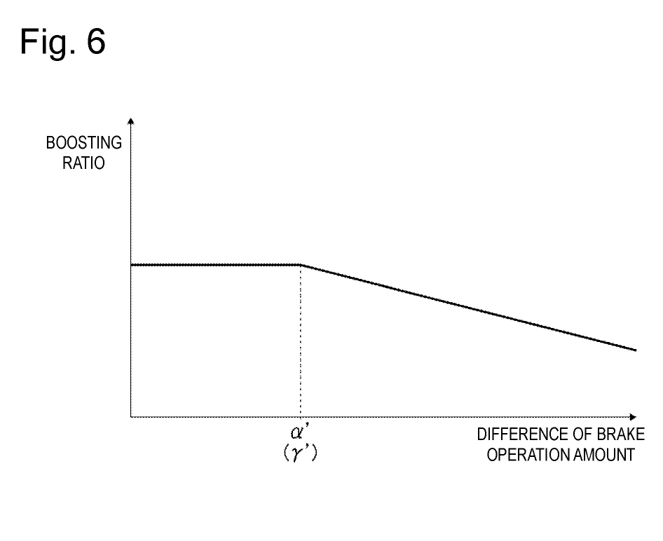

Now, the boosting control corresponding to when the stroke is excessive will be described. FIG. 4 is a flowchart illustrating the boosting control corresponding to when the stroke is excessive according to the first embodiment. In step S41, the control unit CU determines whether the stroke S of the brake pedal BP is longer than a third threshold value, which is a value acquired by adding a boosting ratio reduction control determination value α′ to the estimated stroke Sest of the brake pedal BP. If the determination in step S41 is YES, the processing proceeds to S42. If the determination in step S41 is NO, the processing proceeds to S43. FIG. 6 illustrates a relationship between a difference of the brake operation amount and a boosting ratio in the brake apparatus according to the first embodiment. The brake apparatus reduces the boosting ratio compared to the boosting ratio corresponding to when the brake apparatus operates normally, in a region where a difference (S—Sest) between the stroke S of the brake pedal BP, which is the brake operation amount input by the driver, and the estimated stroke Sest of the brake pedal BP is larger than the boosting ratio reduction control determination value α′. This setting allows the driver to be effectively notified of the fluid leak.

In step S42, the control unit CU performs boosting ratio reduction control for reducing the target hydraulic pressures of the wheel cylinders W/C with respect to the stroke S, which is the brake operation amount, compared to when the brake apparatus operates normally. The brake apparatus prompts the driver to repair the vehicle by intentionally reducing the boosting ratio if a large difference is generated between the relationship between the master pressure Pmc and the stroke S of the brake pedal BP when the brake apparatus operates normally, and the relationship of the value detected by the stroke sensor 1. In step S43, the control unit CU continuously performs the boosting control corresponding to when the brake apparatus operates normally.

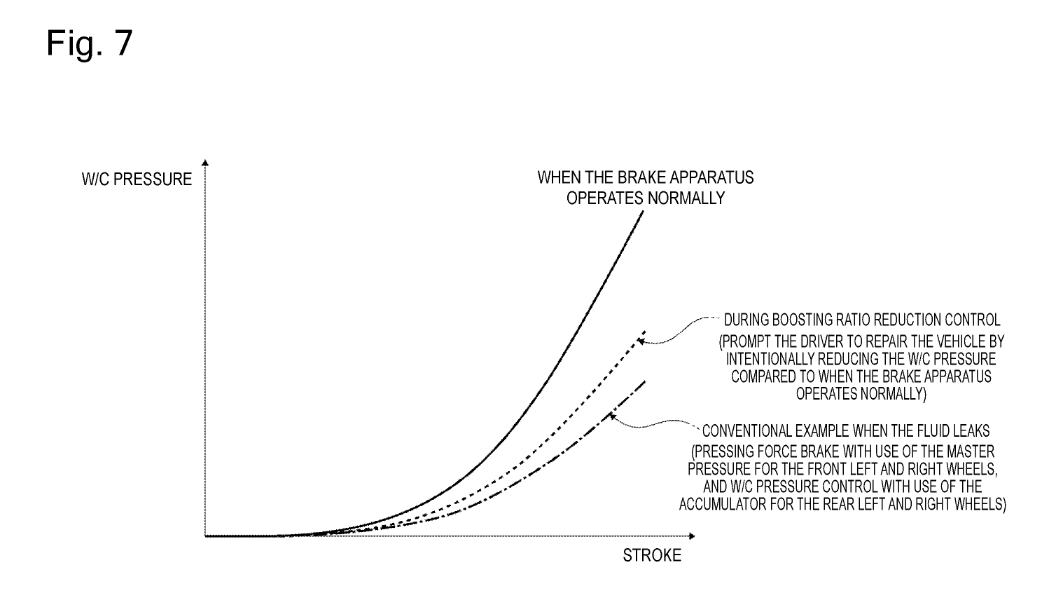

FIG. 7 illustrates a relationship between the stroke S and the wheel cylinder W/C pressure in the brake apparatus according to the first embodiment. For example, the brake apparatus discussed in PTL 1 switches the hydraulic control of the front left and right wheels to pressing force brake with use of the master pressure at the time of the fluid leak. Therefore, this brake apparatus may lead to reductions in the wheel cylinder W/C pressures with respect to the brake operation amount input by the driver compared to when the brake apparatus operates normally, thereby resulting in insufficiency of the braking force on the vehicle. On the other hand, in the hydraulic control of the wheel cylinders W/C according to the first embodiment, the brake apparatus continues the boosting control of the wheel cylinders W/C with use of the plunger pump PP if such a failure that the stroke S becomes excessive, i.e., the fluid leak is determined to have occurred due to, for example, the fluid leak at the master cylinder M/C, from the relationship between the master pressure Pmc and the stroke S of the brake pedal BP, which are the brake operation amount input by the driver.

Basically, a target braking force generated by the driver can be realized as long as the brake fluid does not leak between the valve unit BU and the wheel cylinders W/C. Now, in the case where the target braking force is generated based on, for example, the stroke S, the fluid leak between the master cylinder unit MU and the valve unit BU only results in generation of a relatively strong target braking force compared to the target braking force corresponding to when the brake apparatus operates normally without the fluid leak because the stroke S can easily increase in this case. Further, even when the fluid leak has occurred, the target hydraulic pressures are generated as long as the master pressure Pmc is generated. Therefore, when the fluid leak has occurred, it is more useful to continue the boosting control based on the target braking force set to the relatively large value than selecting the pressing force brake, which raises a risk of the reduction in the braking force, from the viewpoint of a necessity of securing the braking force. Determining the fluid leak based on the relationship between the stroke S and the master pressure Pmc at the time of the boosting control is equivalent to detecting the fluid leak between the master cylinder unit MU and the valve unit BU, and the braking force can be secured by identifying thereby a location where the fluid leak has occurred.

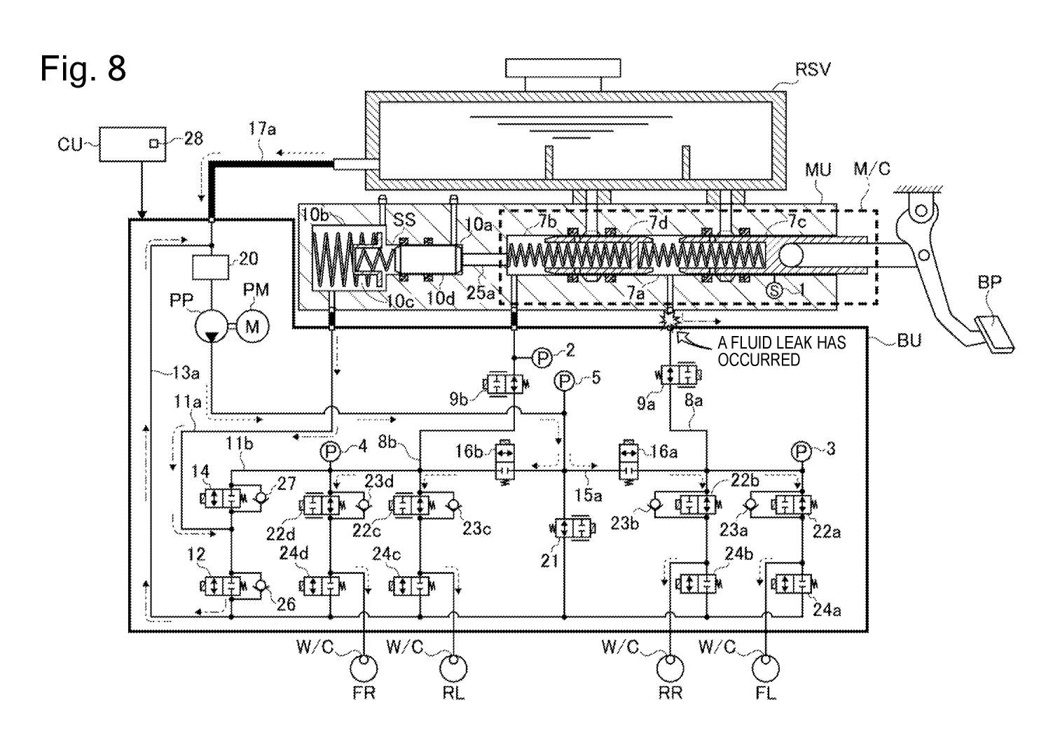

FIG. 8 illustrates a flow of the brake fluid at the time of the boosting control when the fluid leak has occurred according to the first embodiment. In FIG. 8, an alternate long and short dash line indicates a flow of the brake fluid flowing according to the stroke S, and a dotted line indicates a flow of the brake fluid discharged from the plunger pump PP. As illustrated in FIG. 8, the brake apparatus allows the braking force to be applied to the vehicle according to the brake operation amount input by the driver even when a failure such as the fluid leak has occurred at the master cylinder M/C. However, if the relationship between the master pressure Pmc and the stroke S of the brake pedal BP, which are the brake operation amount input by the driver, is largely changed from this relationship corresponding to when the brake apparatus operates normally (the difference is larger than a′), the present configuration performs the boosting ratio reduction control, thereby allowing the brake apparatus to prompt the driver to repair the vehicle.

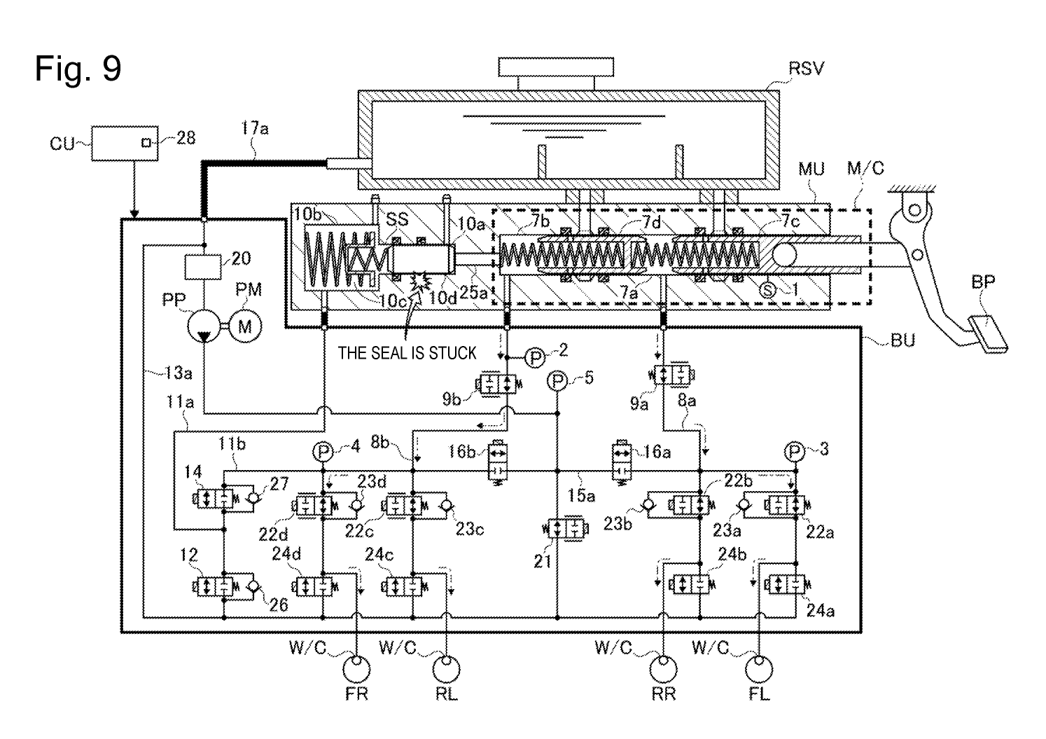

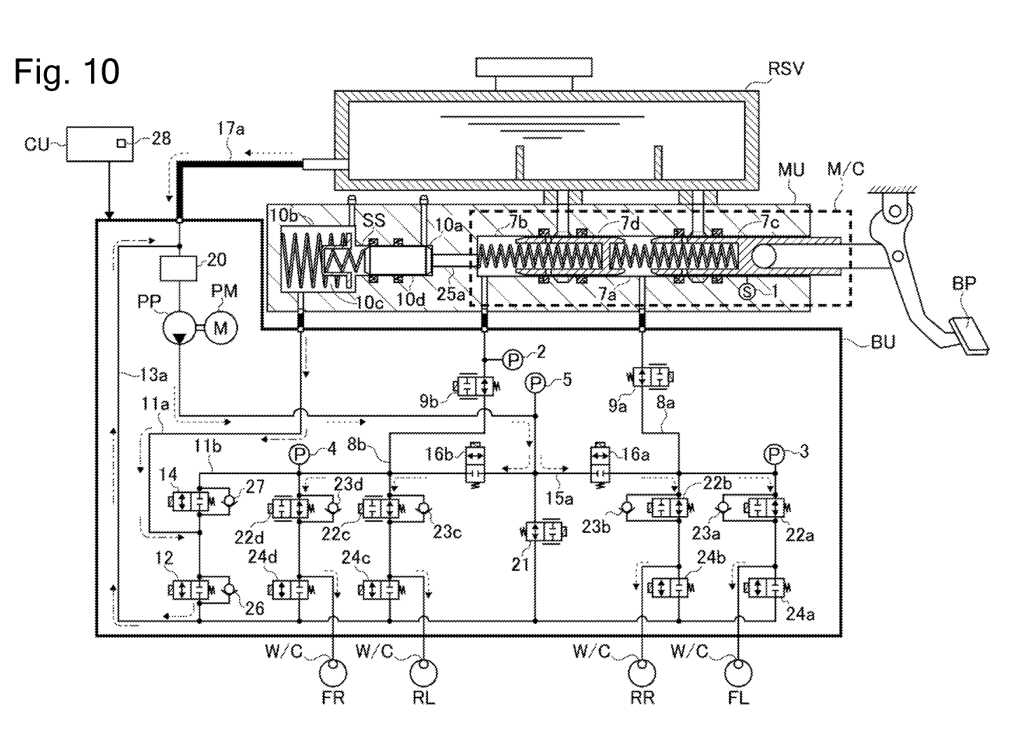

Referring back to FIG. 3, in step S5, the control unit CU determines whether the stroke S of the brake pedal BP is shorter than a second threshold value, which is a value acquired by subtracting a stroke insufficiency determination value β (pressing force brake determination value based on the stroke) from the estimated stroke Sest of the brake pedal BP. If the determination in step S5 is YES, the processing proceeds to step S6. If the determination in step S5 is NO, the processing proceeds to step S7. In step S6, the control unit CU performs hydraulic control of the wheel cylinders W/C corresponding to when the stroke is insufficient. When the stroke is insufficient, the brake apparatus deactivates the boosting control of the wheel cylinders W/C with use of the plunger pump PP, and performs the pressing force brake with use of the master pressure Pmc generated by the master cylinder M/C, which is a manual hydraulic source. FIG. 9 illustrates a flow of the brake fluid at the time of the pressing force brake when a seal is stuck according to the first embodiment. In FIG. 9, an alternate long and short dash line indicates a flow of the brake fluid flowing according to the stroke S. The brake apparatus can also perform the above-described pressing force brake when a failure of being stuck in an opened state has occurred in the primary cut valve 9a or the secondary cut valve 9b. In step S7, the control unit CU performs the boosting control corresponding to when the brake apparatus operates normally. When the brake apparatus operates normally, the brake apparatus calculates the target hydraulic pressures of the wheel cylinders W/C from the individual detected value of the stroke S of the brake pedal BP or the master pressure Pmc, and controls the wheel cylinder W/C pressures so as to achieve the target hydraulic pressures. FIG. 10 illustrates a flow of the brake fluid at the time of the boosting control when the brake apparatus operates normally according to the first embodiment. In FIG. 10, an alternate long and short dash line indicates a flow of the brake fluid flowing according to the stroke S, and a dotted line indicates a flow of the brake fluid discharged from the plunger pump PP.

In the above-described manner, the first embodiment brings about the following advantageous effects.

(1) The brake apparatus includes the stroke sensor 1 configured to detect the stroke S of the brake pedal BP, the master cylinder M/C (a first hydraulic source) configured to generate the brake hydraulic pressure in the wheel cylinder W/C according to the operation performed on the brake pedal BP, the master pressure sensor 2 (a first hydraulic source pressure sensor) configured to detect the pressure of the master cylinder M/C, the housing of the valve unit BU connected to the master cylinder M/C and including the oil passage therein, the plunger pump PP (a second hydraulic source) provided in the housing and configured to generate the brake hydraulic pressure in the wheel cylinder W/C with use of the hydraulic source other than the operation performed on the brake pedal BP, and the control unit CU configured to perform control so as to continue the generation of the brake hydraulic pressure in the wheel cylinder W/C with use of the plunger pump PP (the second hydraulic source) if the fluid leak of the brake fluid is determined based on the preset relationship between the hydraulic pressure Pmc of the master cylinder M/C and the stroke S of the brake pedal BP. Therefore, the first embodiment allows the brake apparatus to realize the braking force on the vehicle according to the brake operation amount input by the driver even at the time of the occurrence of such a failure that the stroke S of the brake pedal BP becomes excessive compared to when the brake apparatus operates normally due to, for example, the fluid leak at the master cylinder M/C.

(2) The brake apparatus further includes step S2 (an estimated stroke calculation portion) configured to calculate the estimated stroke Sest of the brake pedal BP based on the preset relationship between the hydraulic pressure of the master cylinder M/C and the stroke S. The control unit CU determines the fluid leak if the stroke S detected by the stroke sensor 1 is longer than the first threshold value acquired by adding the stroke excess determination value α to the estimated stroke Sest. Therefore, the first embodiment allows the brake apparatus to determine a state in which the stroke is excessive, without adding a new sensor.

(3) The control unit CU generates the brake hydraulic pressure in the wheel cylinder W/C with use of the master cylinder M/C while deactivating the control for generating the brake hydraulic pressure in the wheel cylinder W/C with use of the plunger pump PP if the stroke S detected by the stroke sensor 1 is shorter than the second threshold value acquired by subtracting the stroke insufficiency determination value β from the estimated stroke Sest. Therefore, the first embodiment allows the brake apparatus to switch the brake control to the pressing force brake, thereby securing the minimum braking force on the vehicle, at the time of occurrence of such a failure that the stroke S becomes insufficient compared to when the brake apparatus operates normally due to, for example, the stuck seal of the stroke simulator SS.

(4) The control unit CU performs control in such a manner that the hydraulic pressure in the wheel cylinder W/C falls below the preset hydraulic pressure if the stroke S detected by the stroke sensor 1 is longer than the third threshold value acquired by adding the first boosting ratio reduction control determination value α′ larger than the stroke excess determination value α to the estimated stroke Sest. Therefore, the first embodiment allows the brake apparatus to prompt the driver to repair the vehicle by intentionally reducing an effect of the brake at the time of the occurrence of such a failure that the stroke S becomes excessive compared to when the brake apparatus operates normally due to, for example, the fluid leak at the master cylinder M/C.

(5) A brake system includes the master cylinder unit MU (a first unit) including the master cylinder M/C configured to generate the hydraulic pressure in the wheel cylinder W/C provided at the wheel according to the operation performed on the brake pedal BP, the valve unit BU (a second unit) including the housing connected to the master cylinder unit MU and having the oil passage therein and the plunger pump PP (a hydraulic source) provided in the housing and configured to generate the hydraulic pressure in the wheel cylinder W/C provided at the wheel via the oil passage in the housing, and steps S1 to S3 (a fluid leak detection portion) configured to detect the fluid leak between the master cylinder unit MU and the valve unit BU. Therefore, the first embodiment allows the brake apparatus to reduce the insufficiency of the braking force at the time of the fluid leak. Further, the first embodiment allows the brake apparatus to detect the fluid leak between the master cylinder unit MU and the valve unit BU.

(6) The master cylinder unit MU includes the stroke simulator SS configured in such a manner that the brake fluid flowing out from the master cylinder M/C is introduced therein and configured to generate the simulated operation reaction force of the brake pedal BP (a brake operation member). Therefore, the first embodiment allows the brake apparatus to check the fluid leak at both the master cylinder M/C and the stroke simulator SS.

### Second Embodiment

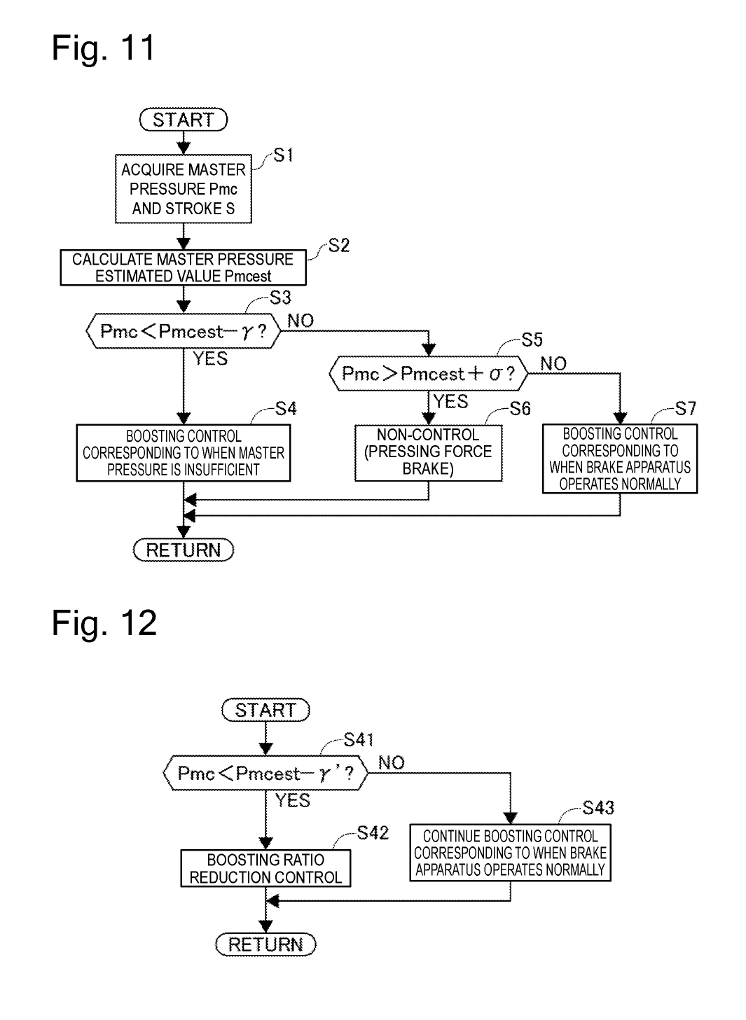

Next, a second embodiment will be described. The second embodiment has a basic configuration similar to the first embodiment, and therefore will be described focusing on only differences therefrom. FIG. 11 is a flowchart illustrating a flow of switching the boosting control when the failure is determined based on an estimated master pressure Sest that is performed by the control unit CU according to the second embodiment.

In step S1, the control unit CU acquires the stroke S of the brake pedal BP and the master pressure Pmc.

In step S2, the control unit CU calculates the estimated master pressure Pmcest. The estimated master pressure Pmcest is a value calculated based on the relationship between the master pressure Pmc and the stroke S of the brake pedal BP when the brake apparatus operates normally, as illustrated in FIG. 5.

In step S3, the control unit CU determines whether the master pressure Pmc is lower than a fourth threshold value, which is a value acquired by subtracting a normal boosting control continuation determination value γ from the estimated master pressure Pmcest. If the determination in step S3 is YES, the processing proceeds to S4. If the determination in step S3 is NO, the processing proceeds to S5.

In step S4, the control unit CU performs the boosting control corresponding to when the master pressure is insufficient.

FIG. 12 is a flowchart illustrating boosting control corresponding to when the master pressure is insufficient according to the first embodiment. In step S41, the control unit CU determines whether the master pressure Pmc is lower than a sixth threshold value, which is a value acquired by subtracting a boosting ratio reduction control determination value γ′ from the estimated master pressure Pmcest. If the determination in step S41 is YES, the processing proceeds to S42. If the determination in step S41 is NO, the processing proceeds to S43. In step S42, the control unit CU performs the boosting ratio reduction control for reducing the target hydraulic pressures of the wheel cylinders W/C with respect to the stroke, which is the brake operation amount, compared to when the brake apparatus operates normally, as illustrated in FIG. 7. This control is performed for the purpose of prompting the driver to repair the vehicle by intentionally reducing the boosting ratio compared to when the brake apparatus operates normally. In step S43, the control unit CU continuously performs the boosting control corresponding to when the brake apparatus operates normally.

Referring back to FIG. 11, in step S5, the control unit CU determines whether the master pressure Pmc is higher than a fifth threshold value, which is a value acquired by adding a master pressure excess determination value σ (a pressing force brake determination threshold value based on the master pressure) to the estimated master pressure Pmcest. If the determination in step S5 is YES, the processing proceeds to step S6. If the determination in step S5 is NO, the processing proceeds to step S7. In step S6, the control unit CU performs hydraulic control of the wheel cylinders W/C corresponding to when the master pressure is excessive. When the master pressure is excessive, the brake apparatus deactivates the boosting control of the wheel cylinders W/C with use of the plunger pump PP, which is a powered hydraulic source, and performs the pressing force brake with use of the master pressure generated by the master cylinder M/C, which is the manual hydraulic source. The brake apparatus can also perform the above-described pressing force brake even when the failure of being stuck in the opened state has occurred in the primary cut valve 9a or the secondary cut valve 9b. In step S7, the control unit CU performs the boosting control corresponding to when the brake apparatus operates normally. When the brake apparatus operates normally, the brake apparatus calculates the target hydraulic pressures of the wheel cylinders W/C from the individual detected value of the stroke S of the brake pedal BP or the master pressure Pmc, and controls the wheel cylinder W/C pressures so as to achieve the target hydraulic pressures.

In the above-described manner, the second embodiment brings about the following advantageous effects in addition to (1), (5), and (6) of the first embodiment.

(7) The brake apparatus further includes the step S2 (a first hydraulic source estimated hydraulic pressure calculation portion) configured to calculate the estimated hydraulic pressure Pmsest of the master cylinder M/C based on the preset relationship between the hydraulic pressure of the master cylinder M/C and the stroke S of the brake pedal BP. The control unit CU determines the fluid leak if the hydraulic pressure detected by the master pressure sensor 2 (the first hydraulic source pressure sensor) is lower than the fourth threshold value acquired by subtracting the normal boosting control continuation determination value γ (a master pressure insufficiency determination value) from the estimated hydraulic pressure Pmcest. Therefore, the second embodiment allows the brake apparatus to realize the braking force on the vehicle according to the brake operation amount input by the driver even at the time of the occurrence of such a failure that the master pressure Pmc becomes insufficient compared to when the brake apparatus operates normally due to, for example, the fluid leak at the master cylinder M/C.

(8) The control unit CU generates the brake hydraulic pressure in the wheel cylinder W/C with use of the master cylinder M/C while deactivating the control for generating the brake hydraulic pressure in the wheel cylinder W/C with use of the plunger pump PP if the hydraulic pressure detected by the master pressure sensor 2 is higher than the fifth threshold value acquired by adding the master pressure excess determination value σ to the estimated pressure Pmcest. Therefore, the second embodiment allows the brake apparatus to switch the brake control to the pressing force brake, thereby securing the minimum braking force on the vehicle, at the time of occurrence of such a failure that the master pressure Pmc becomes excessive compared to when the brake apparatus operates normally due to, for example, the stuck seal of the stroke simulator SS.

(9) The control unit CU performs control in such a manner that the hydraulic pressure in the wheel cylinder falls below the preset hydraulic pressure if the hydraulic pressure detected by the master pressure sensor 2 is lower than the sixth threshold value acquired by subtracting the boosting ratio reduction control determination value γ′ (a second boosting ratio reduction control determination value) larger than the normal boosting control continuation determination value γ from the estimated hydraulic pressure Pmcest. Therefore, the second embodiment allows the brake apparatus to prompt the driver to repair the vehicle by intentionally reducing the effect of the brake at the time of the occurrence of such a failure that the master pressure becomes insufficient compared to when the brake apparatus operates normally due to, for example, the fluid leak at the master cylinder M/C.

### Third Embodiment

Next, a third embodiment will be described. The third embodiment has a basic configuration similar to the first and second embodiments, and therefore will be described focusing on only differences therefrom. The brake apparatus determines the fluid leak or the like based on the stroke S (hereinafter also referred to as stroke-based control) in the first embodiment, and determines the fluid leak or the like based on the master pressure Pmc (hereinafter also referred to as master pressure-based control) in the second embodiment. On the other hand, in the third embodiment, the brake apparatus is configured to switch the stroke-based control and the master pressure-based control based on a switching master pressure threshold value Pmcch. More specifically, as illustrated in FIG. 5, in a low master pressure region, the stroke-based control can achieve higher estimation accuracy than the master pressure-based control because a change rate of the stroke is higher than a change rate of the master pressure. On the other hand, in a high master pressure region, the master pressure-based control can achieve higher estimation accuracy than the stroke-based control because the change rate of the master pressure is higher than the change rate of the stroke. Therefore, in the third embodiment, the brake apparatus is configured to select the control capable of achieving the higher estimation accuracy according to a situation.

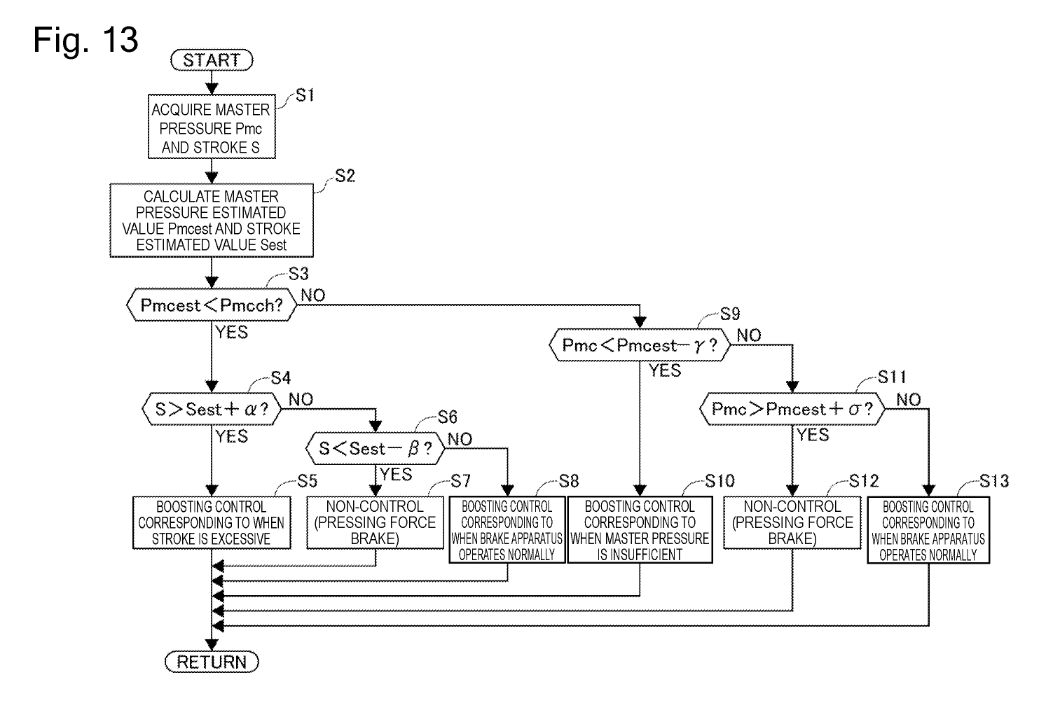

FIG. 13 is a flowchart illustrating a flow when the method for determining the switching of the boosting control is switched that is performed by the control unit CU according to the third embodiment. In step S1, the control unit CU acquires the stroke S of the brake pedal BP and the master pressure Pmc. In step S2, the control unit CU calculates the estimated stroke Sest of the brake pedal BP and the estimated master pressure Pmcest. In step S3, the control unit CU determines whether the master pressure Pmc is lower than the switching master pressure threshold value Pmcch. If the determination in step S3 is YES, the processing proceeds to S4. If the determination in step S3 is NO, the processing proceeds to S9. In steps S4 to S8, the control unit CU performs processing similar to steps S3 to S7 according to the first embodiment. In steps S9 to S13, the control unit CU performs processing similar to steps S3 to S7 according to the second embodiment.

In the above-described manner, the third embodiment brings about the following advantageous effects in addition to the advantageous effects of the first and second embodiments.

(10) The brake apparatus includes step S2 (an estimated stroke calculation portion) configured to calculate the estimated stroke Sest of the brake pedal based on the preset relationship between the hydraulic pressure of the master cylinder M/C and the stroke S, and step S2 (a first hydraulic source estimated hydraulic pressure calculation portion) configured to calculate the estimated hydraulic pressure of the master cylinder M/C based on the preset relationship between the hydraulic pressure of the master cylinder M/C and the stroke S. The control unit CU includes step 3 (a fluid leak determination selection portion) configured to determine the fluid leak based on the stroke S, which is the value detected by the stroke sensor 1, and the estimated stroke Sest if the estimated master pressure Pmcest (the estimated hydraulic pressure) is lower than the switching master pressure threshold value Pmcch, and determine the fluid leak based on the master pressure Pmc, which is the value detected by the master pressure sensor 2, and the estimated hydraulic pressure Pmcest if the estimated master pressure Pmcest is higher than the switching master pressure threshold value Pmcch. Therefore, the third embodiment allows the brake apparatus to select the optimum method for determining the switching of the boosting control at the time of the occurrence of such a failure that the stroke S of the brake pedal BP becomes excessive or the master pressure becomes insufficient compared to when the brake apparatus operates normally due to, for example, the fluid leak at the master cylinder M/C.

### Fourth Embodiment

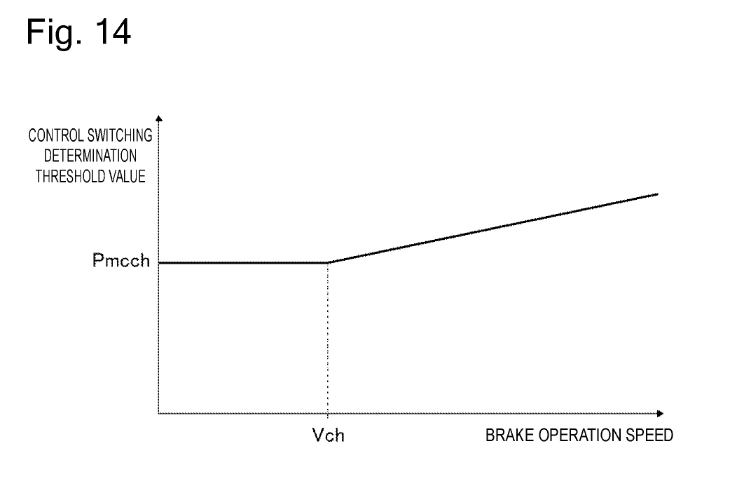

Next, a fourth embodiment will be described. The fourth embodiment has a basic configuration similar to the third embodiment, and therefore will be described focusing on only differences therefrom. In the first to third embodiments, fixed values are used as the control switching determination values and the threshold values such as the stroke excess determination value α, the stroke insufficiency determination value β, the normal boosting control continuation determination value γ, the master pressure excess determination value σ, and the switching master pressure threshold value Pmcch (hereinafter, these values will be also referred to as control switching determination threshold values). On the other hand, in the fourth embodiment, the brake apparatus detects a brake operation speed, and increases the control switching determination threshold values according to the brake operation speed when the brake operation speed is higher than a switching speed threshold value Vch. FIG. 14 illustrates a relationship between the brake operation speed and a switching master pressure threshold value according to the fourth embodiment. More specifically, when the brake operation speed is high, an error may occur in the detection of the various kinds of sensors. Therefore, when the brake operation speed is high, the brake apparatus avoids an incorrect determination by preparing an extra time until the control is switched. FIG. 14 illustrates a tendency of each of the control switching determination threshold values, and each of the values is set individually. Further, the brake operation speed may be any value calculated with use of, for example, a differential value of the stroke S detected by the stroke sensor 1, and is not especially limited.

In the above-described manner, the fourth embodiment brings about the following advantageous effects in addition to the advantageous effects of the first to third embodiments.

(11) The control unit CU increases the stroke excess determination value α and the stroke insufficiency determination value β according to the increase in the speed of the operation performed on the brake pedal if the speed of the operation performed on the brake pedal BP is higher than the switching speed threshold value Vch. In other words, the fourth embodiment allows the brake apparatus to prevent incorrect activation of the control switching, because a difference is likely generated between the relationship between the master pressure Pmc and the stroke S of the brake pedal BP when the brake apparatus operates normally, and the relationship of the individual value detected by the stroke sensor 1 or the master pressure sensor 2, when the brake operation speed is high.

(12) The control unit CU increases the normal boosting control continuation determination value γ (the master pressure insufficiency determination value) and the master pressure excess determination value σ according to the increase in the speed of the operation performed on the brake pedal BP if the speed of the operation performed on the brake pedal BP is higher than the switching speed threshold value Vch. In other words, the fourth embodiment allows the brake apparatus to prevent incorrect activation of the control switching, because a difference is likely generated between the relationship between the master pressure Pmc and the stroke S of the brake pedal BP when the brake apparatus operates normally, and the relationship of the individual value detected by the stroke sensor 1 or the master pressure sensor 2, when the brake operation speed is high.

(13) The control unit CU determines the fluid leak when the stroke S detected by the stroke sensor 1 is longer than the first threshold value acquired by adding the stroke excess determination value α to the estimated stroke Sest, if the estimated master pressure Pmcest is lower than the switching master pressure threshold value Pmcch. Therefore, the fourth embodiment allows the brake apparatus to determine the state in which the stroke is excessive without adding a new sensor. The fourth embodiment allows the brake apparatus to highly accurately determine the fluid leak because the stroke sensor 1 achieves the high detection accuracy when the master pressure Pmc is low.

(14) The control unit CU determines the fluid leak when the hydraulic pressure detected by the master pressure sensor 2 is lower than the fourth threshold value acquired by subtracting the master pressure insufficiency determination value from the estimated master pressure Pmcest, if the estimated master pressure Pmcest is higher than the switching master pressure threshold value Pmcch. Therefore, the fourth embodiment allows the brake apparatus to determine the state in which the stroke is excessive without adding a new sensor. The fourth embodiment allows the brake apparatus to highly accurately determine the fluid leak because the master pressure sensor 2 achieves the high detection accuracy when the master pressure Pmc is high.

### Fifth Embodiment

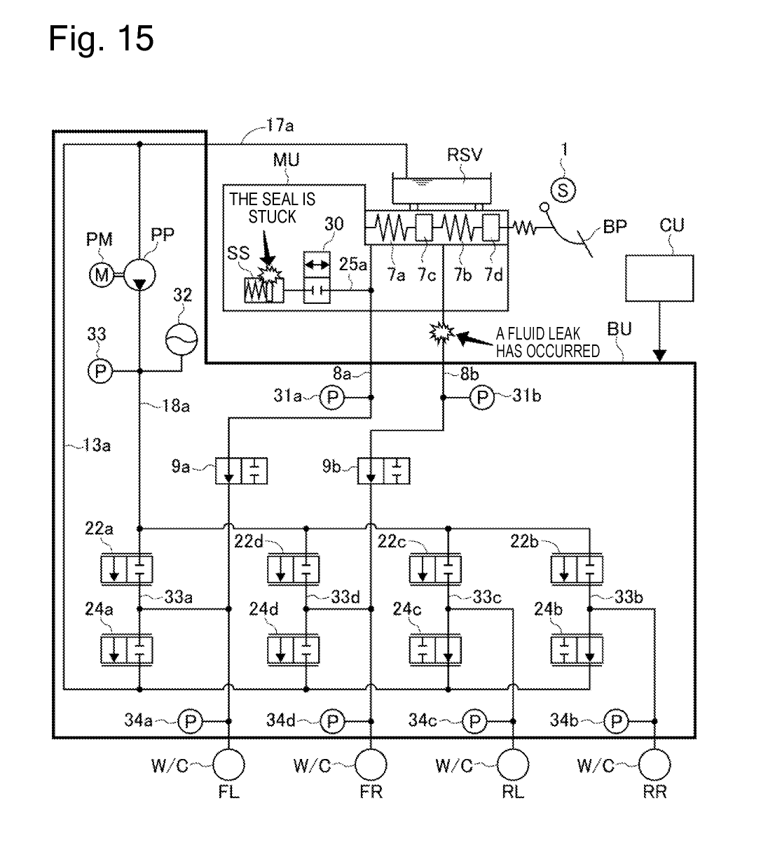

FIG. 15 illustrates a brake apparatus according to a fifth embodiment. Similar portions to the first embodiment will be identified by the same reference numerals, and descriptions thereof will be omitted. The brake apparatus according to the fifth embodiment is a brake apparatus including an electromagnetic opening/closing valve (a stroke simulator adjustment valve) 30 that replaces the stroke simulator OUT valve 12 according to the first embodiment. The electromagnetic opening/closing valve 30 is provided in the oil passage 25a. Further, in the fifth embodiment, the stroke simulator IN valve 14, the primary communication valve 16a, the secondary communication valve 16b, and the pressure adjustment valve 21 according to the first embodiment are omitted. The oil passage 8a is connected to only the wheel cylinder W/C of the front left wheel FL, and the oil passage 8b is connected to only the wheel cylinder W/C of the front right wheel FR. A secondary-side master pressure sensor 31a is provided in the oil passage 8a on an upstream side of the secondary cut valve 9a. Further, a primary-side master pressure sensor 31b is provided in the oil passage 8b on an upstream side of the primary cut valve 9b. An accumulator 32 and an accumulator pressure sensor 33 are provided in an oil passage 18a. The accumulator 32 accumulates the brake fluid pressurized by the activation of the plunger pump PP. The accumulator pressure sensor 33 detects a pressure of the accumulator 32. The oil passage 18a is connected to the pressure increase valves 22a, 22b, 22c, and 22d via oil passages 33a, 33b, 33c, and 33d, respectively. Wheel pressure sensors 34a, 34b, 34c, and 34d are provided in the oil passages 33a, 33b, 33c, and 33d, respectively.

In FIG. 15, if determining occurrence of such a failure that the fluid leak has occurred in the oil passage 8b and the stroke S of the brake pedal BP becomes excessive compared to when the brake apparatus operates normally, the brake apparatus controls the electromagnetic opening/closing valve 30 in its valve-opening direction, controls the secondary cut valve 9a and the primary cut valve 9b in their valve-closing directions, and controls the pump motor PM, the accumulator 32, and the pressure increase valves 22a, 22b, 22c, and 22d in such a manner that the wheel pressure sensors 34a, 34b, 34c, and 34d achieve the target hydraulic pressures, thereby performing the boosting control of the wheel cylinders W/C in a similar manner to when the brake apparatus operates normally. On the other hand, if determining occurrence of such a failure that the seal of the stroke simulator SS is stuck and the stroke S of the brake pedal BP becomes insufficient compared to when the brake apparatus operates normally, the brake apparatus closes the electromagnetic opening/closing valve 30, opens the secondary cut valve 9a and the primary cut valve 9b, and closes the pressure increase valves 22a and 22d, thereby applying the pressing force brake to the wheel cylinder FL and the wheel cylinder FR while applying the boosting control to the wheel cylinder RL and the wheel cylinder RR by controlling the pump motor PM, the accumulator 32, and the pressure increase valves 22b and 22d in such a manner that the wheel pressure sensors 34b and 34c achieve the target hydraulic pressures, thus providing a minimum braking force to the vehicle. In this manner, the brake apparatus different from the first to fourth embodiments can also bring about similar advantageous effects to the first to fourth embodiments.

In the following description, technical ideas recognizable from the above-described embodiments will be described. A brake apparatus includes a stroke sensor configured to detect a stroke of a brake pedal, a first hydraulic source configured to generate a brake hydraulic pressure in a wheel cylinder according to an operation performed on the brake pedal, a first hydraulic source pressure sensor configured to detect a pressure of the first hydraulic source, a housing connected to the first hydraulic source and including an oil passage therein, a second hydraulic source provided in the housing and configured to generate the brake hydraulic pressure in the wheel cylinder with use of a hydraulic source other than the operation performed on the brake pedal, and a control unit configured to perform control so as to continue the generation of the brake hydraulic pressure in the wheel cylinder with use of the second hydraulic source if a fluid leak of brake fluid is determined based on a preset relationship between the hydraulic pressure of the first hydraulic source and the stroke of the brake pedal. According to a further preferable aspect, in the above-described aspect, the brake apparatus further includes an estimated stroke calculation portion configured to calculate an estimated stroke of the brake pedal based on the preset relationship between the hydraulic pressure of the first hydraulic source and the stroke. The control unit determines the fluid leak if the stroke detected by the stroke sensor is longer than a first threshold value acquired by adding a stroke excess determination value to the estimated stroke.

According to another further preferable aspect, in any of the above-described aspects, the control unit generates the brake hydraulic pressure in the wheel cylinder with use of the first hydraulic source while deactivating control for generating the brake hydraulic pressure in the wheel cylinder with use of the second hydraulic source if the stroke detected by the stroke sensor is shorter than a second threshold value acquired by subtracting a stroke insufficiency determination value from the estimated stroke. According to another further preferable aspect, in any of the above-described aspects, the control unit performs control in such a manner that the hydraulic pressure in the wheel cylinder falls below a preset hydraulic pressure if the stroke detected by the stroke sensor is longer than a third threshold value acquired by adding a first boosting ratio reduction control determination value larger than the stroke excess determination value to the estimated stroke. According to another further preferable aspect, in any of the above-described aspects, the control unit increases the stroke excess determination value and the stroke insufficiency determination value according to an increase in a speed of the operation performed on the brake pedal if the speed of the operation performed on the brake pedal is higher than a switching speed threshold value.

According to another further preferable aspect, any of the above-described aspects further includes a first hydraulic source estimated hydraulic pressure calculation portion configured to calculate an estimated hydraulic pressure of the first hydraulic source based on the preset relationship between the hydraulic pressure of the first hydraulic source and the stroke of the brake pedal. The control unit determines the fluid leak if the hydraulic pressure detected by the first hydraulic source pressure sensor is lower than a fourth threshold value acquired by subtracting a master pressure insufficiency determination value from the estimated hydraulic pressure of the first hydraulic source. According to another further preferable aspect, in any of the above-described aspects, the control unit generates the brake hydraulic pressure in the wheel cylinder with use of the first hydraulic source while deactivating the control for generating the brake hydraulic pressure in the wheel cylinder with use of the second hydraulic source if the hydraulic pressure detected by the first hydraulic source pressure sensor is higher than a fifth threshold value acquired by adding a master pressure excess determination value to the estimated pressure of the first hydraulic source. According to another further preferable aspect, in any of the above-described aspects, the control unit performs control in such a manner that the hydraulic pressure in the wheel cylinder falls below a preset hydraulic pressure if the hydraulic pressure detected by the first hydraulic source pressure sensor is lower than a sixth threshold value acquired by subtracting a second boosting ratio reduction control determination value larger than the master pressure insufficiency determination value from the estimated hydraulic pressure of the first hydraulic source. According to another further preferable aspect, in any of the above-described aspects, the control unit increases the master pressure insufficiency determination value and the master pressure excess determination value according to an increase in a speed of the operation performed on the brake pedal if the speed of the operation performed on the brake pedal is higher than a switching speed threshold value. According to another further preferable aspect, any of the above-described aspects further includes an estimated stroke calculation portion configured to calculate an estimated stroke of the brake pedal based on the preset relationship between the hydraulic pressure of the first hydraulic source and the stroke, and a first hydraulic source estimated hydraulic pressure calculation portion configured to calculate an estimated hydraulic pressure of the first hydraulic source based on the preset relationship between the hydraulic pressure of the first hydraulic source and the stroke. The control unit includes a fluid leak determination selection portion configured to determine the fluid leak based on a value detected by the stroke sensor and the estimated stroke if the estimated hydraulic pressure is lower than a switching master pressure threshold value, and determine the fluid leak based on a value detected by the first hydraulic source pressure sensor and the estimated hydraulic pressure if the estimated hydraulic pressure is higher than the switching master pressure threshold value. According to another further preferable aspect, in any of the above-described aspects, the control unit determines the fluid leak when the stroke detected by the stroke sensor is longer than the first threshold value acquired by adding the stroke excess determination value to the estimated stroke, if the estimated hydraulic pressure is lower than the switching master pressure threshold value. According to another further preferable aspect, in any of the above-described aspects, the control unit determines the fluid leak when the hydraulic pressure detected by the first hydraulic source pressure sensor is lower than the fourth threshold value acquired by subtracting the master pressure insufficiency determination value from the estimated hydraulic pressure, if the estimated hydraulic pressure is higher than the switching master pressure threshold value.

A brake system includes a first unit including a master cylinder configured to generate a hydraulic pressure in a wheel cylinder provided at a wheel according to an operation performed on a brake pedal, a second unit including a housing connected to the first unit and having an oil passage therein and a hydraulic source provided in the housing and configured to generate the hydraulic pressure in the wheel cylinder provided at the wheel via the oil passage, and a fluid leak detection portion configured to detect a fluid leak between the first unit and the second unit. According to another further preferable aspect, in the above-described aspect, the first unit includes a stroke simulator configured in such a manner that brake fluid flowing out from the master cylinder is introduced therein and configured to generate a simulated operation reaction force of a brake operation member.

A method for controlling a brake apparatus is provided. The brake apparatus includes a stroke sensor configured to detect a stroke of a brake pedal, a first hydraulic source configured to generate a brake hydraulic pressure in a wheel cylinder according to an operation performed on the brake pedal, a first hydraulic source pressure sensor configured to detect a pressure of the first hydraulic pressure source, a housing connected to the first hydraulic source and including an oil passage therein, and a second hydraulic source provided in the housing and configured to generate the brake hydraulic pressure in the wheel cylinder with use of a hydraulic source other than the operation performed on the brake pedal. The method for controlling the brake apparatus includes performing control so as to continue the generation of the brake hydraulic pressure in the wheel cylinder with use of the second hydraulic source if a fluid leak of the brake fluid is determined based on a preset relationship between the hydraulic pressure of the first hydraulic source and the stroke. According to another further preferable aspect, in the above-described aspect, the method further includes a first step of detecting the stroke of the brake pedal and the hydraulic pressure of the first hydraulic source, a second step of calculating an estimated stroke of the brake pedal based on the preset relationship between the hydraulic pressure of the first hydraulic source and the stroke, and a third step of determining the fluid leak if the stroke detected by the stroke sensor is longer than a threshold value acquired by adding a stroke excess determination value to the estimated stroke calculated in the second operation. According to another further preferable aspect, in any of the above-described aspects, that the method further includes a fourth step of determining so as to generate the brake hydraulic pressure in the wheel cylinder with use of the first hydraulic source while deactivating control for generating the brake hydraulic pressure in the wheel cylinder with use of the second hydraulic source if the fluid leak is not determined in the third step and the stroke detected in the first step is shorter than a threshold value acquired by subtracting a stroke insufficiency determination value from the estimated stroke calculated in the second step. According to another further preferable aspect, in any of the above-described aspects, the method further includes a first step of detecting the stroke of the brake pedal and the hydraulic pressure of the first hydraulic source, a second step of calculating an estimated hydraulic pressure of the first hydraulic source based on the preset relationship between the hydraulic pressure of the first hydraulic source and the stroke of the brake pedal, and a third step of determining the fluid leak if the hydraulic pressure detected by the first hydraulic source pressure sensor is lower than a threshold value acquired by subtracting a master pressure insufficiency determination value from the estimated hydraulic pressure. According to another further preferable aspect, in any of the above-described aspects, the method further includes a fourth step of determining so as to generate the brake hydraulic pressure in the wheel cylinder with use of the first hydraulic source while deactivating the control for generating the brake hydraulic pressure in the wheel cylinder with use of the second hydraulic source if the fluid leak is not determined in the third step and the hydraulic pressure of the first hydraulic source detected in the first step is higher than a threshold value acquired by adding a master pressure excess determination value to the estimated hydraulic pressure. According to another further preferable aspect, in any of the above-described aspects, the method further includes a first step of detecting the stroke of the brake pedal and the hydraulic pressure of the first hydraulic source, a second step of calculating an estimated stroke of the brake pedal and also calculating an estimated hydraulic pressure of the first hydraulic source, based on the preset relationship between the hydraulic pressure of the first hydraulic source and the stroke, and a fourth step of determining the fluid leak based on the stroke detected in the first step and the estimated stroke if the estimated hydraulic pressure is lower than a switching master pressure threshold value and determining the fluid leak based on the hydraulic pressure of the first hydraulic source detected in the first step and the estimated hydraulic pressure if the estimated hydraulic pressure is higher than the switching master pressure threshold value.

Having described several embodiments of the present invention, the above-described embodiments of the present invention are intended to only facilitate the understanding of the present invention, and are not intended to limit the present invention thereto. Needless to say, the present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2015-239893 filed on Dec. 9, 2015. The entire disclosure of Japanese Patent Application No. 2015-239893 filed on Dec. 9, 2015 including the specification, the claims, the drawings, and the abstract is incorporated herein by reference in its entirety.

### REFERENCE SIGNS LIST

M/C master cylinder
PM pump motor (actuator)
RSV reservoir tank
SS stroke simulator
W/C wheel cylinder
8a oil passage
10a positive pressure chamber
10b backpressure chamber
10c spring
10d piston
11a oil passage
11b oil passage
12 stroke simulator OUT valve (stroke simulator adjustment valve)
25a oil passage
28 brake operation state detection portion
30 electromagnetic opening/closing valve (stroke simulator adjustment valve)

1. A brake apparatus comprising:
a stroke sensor configured to detect a stroke of a brake pedal;
a first hydraulic source configured to generate a brake hydraulic pressure in a wheel cylinder according to an operation performed on the brake pedal;
a first hydraulic source pressure sensor configured to detect a pressure of the first hydraulic source;
a housing connected to the first hydraulic source and including an oil passage therein;
a second hydraulic source provided in the housing and configured to generate the brake hydraulic pressure in the wheel cylinder independently of the operation performed on the brake pedal; and
a control unit configured to perform control so as to continue the generation of the brake hydraulic pressure in the wheel cylinder with use of the second hydraulic source if a fluid leak of brake fluid is determined based on a preset relationship between the hydraulic pressure of the first hydraulic source and the stroke of the brake pedal.

2. The brake apparatus according to claim 1, further comprising an estimated stroke calculation portion configured to calculate an estimated stroke of the brake pedal based on the preset relationship between the hydraulic pressure of the first hydraulic source and the stroke,
wherein the control unit determines the fluid leak if the stroke detected by the stroke sensor is longer than a first threshold value acquired by adding a stroke excess determination value to the estimated stroke.

3. The brake apparatus according to claim 2, wherein the control unit generates the brake hydraulic pressure in the wheel cylinder with use of the first hydraulic source without performing control for generating the brake hydraulic pressure in the wheel cylinder with use of the second hydraulic source if the stroke detected by the stroke sensor is shorter than a second threshold value acquired by subtracting a stroke insufficiency determination value from the estimated stroke.

4. The brake apparatus according to claim 3, wherein the control unit performs control in such a manner that the hydraulic pressure in the wheel cylinder falls below a preset hydraulic pressure if the stroke detected by the stroke sensor is longer than a third threshold value acquired by adding a first boosting ratio reduction control determination value larger than the stroke excess determination value to the estimated stroke.

5. The brake apparatus according to claim 3, wherein the brake apparatus increases the stroke excess determination value and the stroke insufficiency determination value according to an increase in a speed of the operation performed on the brake pedal if the speed of the operation performed on the brake pedal is higher than a switching speed threshold value.

6. The brake apparatus according to claim 1, further comprising a first hydraulic source estimated hydraulic pressure calculation portion configured to calculate an estimated hydraulic pressure of the first hydraulic source based on the preset relationship between the hydraulic pressure of the first hydraulic source and the stroke of the brake pedal,
wherein the control unit determines the fluid leak if the hydraulic pressure detected by the first hydraulic source pressure sensor is lower than a fourth threshold value acquired by subtracting a master pressure insufficiency determination value from the estimated hydraulic pressure of the first hydraulic source.

7. The brake apparatus according to claim 6, wherein the control unit generates the brake hydraulic pressure in the wheel cylinder with use of the first hydraulic source without performing control for generating the brake hydraulic pressure in the wheel cylinder with use of the second hydraulic source if the hydraulic pressure detected by the first hydraulic source pressure sensor is higher than a fifth threshold value acquired by adding a master pressure excess determination value to the estimated pressure of the first hydraulic source.

8. The brake apparatus according to claim 7, wherein the control unit performs control in such a manner that the hydraulic pressure in the wheel cylinder falls below a preset hydraulic pressure if the hydraulic pressure detected by the first hydraulic source pressure sensor is lower than a sixth threshold value acquired by subtracting a second boosting ratio reduction control determination value larger than the master pressure insufficiency determination value from the estimated hydraulic pressure of the first hydraulic source.

9. The brake apparatus according to claim 7, wherein the brake apparatus increases the master pressure insufficiency determination value and the master pressure excess determination value according to an increase in a speed of the operation performed on the brake pedal if the speed of the operation performed on the brake pedal is higher than a switching speed threshold value.

10. The brake apparatus according to claim 1, further comprising:
an estimated stroke calculation portion configured to calculate an estimated stroke of the brake pedal based on the preset relationship between the hydraulic pressure of the first hydraulic source and the stroke; and
a first hydraulic source estimated hydraulic pressure calculation portion configured to calculate an estimated hydraulic pressure of the first hydraulic source based on the preset relationship between the hydraulic pressure of the first hydraulic source and the stroke,
wherein the control unit includes a fluid leak determination selection portion, and
wherein the fluid leak determination selection portion determines the fluid leak based on a value detected by the stroke sensor and the estimated stroke if the estimated hydraulic pressure is lower than a switching master pressure threshold value, and determines the fluid leak based on a value detected by the first hydraulic source pressure sensor and the estimated hydraulic pressure if the estimated hydraulic pressure is higher than the switching master pressure threshold value.

11. The brake apparatus according to claim 10, wherein the control unit determines the fluid leak when the stroke detected by the stroke sensor is longer than a first threshold value acquired by adding a stroke excess determination value to the estimated stroke, if the estimated hydraulic pressure is lower than the switching master pressure threshold value.

12. The brake apparatus according to claim 10, wherein the control unit determines the fluid leak when the hydraulic pressure detected by the first hydraulic source pressure sensor is lower than a fourth threshold value acquired by subtracting a master pressure insufficiency determination value from the estimated hydraulic pressure, if the estimated hydraulic pressure is higher than the switching master pressure threshold value.

13. A brake system comprising:
a first unit including a master cylinder configured to generate an operation hydraulic pressure in a wheel cylinder provided at a wheel according to an operation performed on a brake pedal;
a second unit including a housing connected to the first unit and having an oil passage therein, and a hydraulic source provided in the housing and configured to generate the operation hydraulic pressure in the wheel cylinder provided at the wheel via the oil passage; and
a fluid leak detection portion configured to detect a fluid leak between the first unit and the second unit.

14. The brake system according to claim 13, wherein the first unit includes a stroke simulator configured in such a manner that brake fluid flowing out from the master cylinder is introduced therein, the stroke simulator being configured to generate a simulated operation reaction force of a brake operation member.

15. A method for controlling a brake apparatus, the method comprising:
preparing a brake apparatus including:
a stroke sensor configured to detect a stroke of a brake pedal,
a first hydraulic source configured to generate a brake hydraulic pressure in a wheel cylinder according to an operation performed on the brake pedal,
a first hydraulic source pressure sensor configured to detect a pressure of the first hydraulic pressure,
a housing connected to the first hydraulic source and including an oil passage therein, and
a second hydraulic source provided in the housing and configured to generate the brake hydraulic pressure in the wheel cylinder independently of the operation performed on the brake pedal; and
performing control so as to continue the generation of the brake hydraulic pressure in the wheel cylinder with use of the second hydraulic source if a fluid leak of the brake fluid is determined based on a preset relationship between the hydraulic pressure of the first hydraulic source and the stroke.

16. The method for controlling the brake apparatus according to claim 15, the method further comprising:
a first step of detecting the stroke of the brake pedal and the hydraulic pressure of the first hydraulic source;
a second step of calculating an estimated stroke of the brake pedal based on the preset relationship between the hydraulic pressure of the first hydraulic source and the stroke; and
a third step of determining the fluid leak if the stroke detected by the stroke sensor is longer than a threshold value acquired by adding a stroke excess determination value to the estimated stroke calculated in the second step.

17. The method for controlling the brake apparatus according to claim 16, the method further comprising a fourth step of determining so as to generate the brake hydraulic pressure in the wheel cylinder with use of the first hydraulic source without performing control for generating the brake hydraulic pressure in the wheel cylinder with use of the second hydraulic source if the fluid leak is not determined in the third step and the stroke detected in the first step is shorter than a threshold value acquired by subtracting a stroke insufficiency determination value from the estimated stroke calculated in the second step.

18. The method for controlling the brake apparatus according to claim 15, the method further comprising:
a first step of detecting the stroke of the brake pedal and the hydraulic pressure of the first hydraulic source;
a second step of calculating an estimated hydraulic pressure of the first hydraulic source based on the preset relationship between the hydraulic pressure of the first hydraulic source and the stroke of the brake pedal; and
a third step of determining the fluid leak if the hydraulic pressure detected by the first hydraulic source pressure sensor is lower than a threshold value acquired by subtracting a master pressure insufficiency determination value from the estimated hydraulic pressure.

19. The method for controlling the brake apparatus according to claim 18, the method further comprising a fourth step of determining so as to generate the brake hydraulic pressure in the wheel cylinder with use of the first hydraulic source without performing control for generating the brake hydraulic pressure in the wheel cylinder with use of the second hydraulic source if the fluid leak is not determined in the third step and the hydraulic pressure of the first hydraulic source detected in the first step is higher than a threshold value acquired by adding a master pressure excess determination value to the estimated hydraulic pressure.

20. The method for controlling the brake apparatus according to claim 15, the method further comprising:
a first step of detecting the stroke of the brake pedal and the hydraulic pressure of the first hydraulic source;
a second step of calculating an estimated stroke of the brake pedal and also calculating an estimated hydraulic pressure of the first hydraulic source, based on the preset relationship between the hydraulic pressure of the first hydraulic source and the stroke; and
a fourth step of selecting so as to determine the fluid leak based on the stroke detected in the first operation and the estimated stroke if the estimated hydraulic pressure is lower than a switching master pressure threshold value, and determining the fluid leak based on the hydraulic pressure of the first hydraulic source detected in the first step and the estimated hydraulic pressure if the estimated hydraulic pressure is higher than the switching master pressure threshold value.
